(19) United States
(12) Patent Application Publication
(10) Pub. No.: US 2016/0258428 A1
(43) Pub. Date: Sep. 8, 2016

(54) ELECTROOSMOTIC PUMP, METHOD FOR MANUFACTURING SAME, AND MICROFLUIDIC DEVICE

(71) Applicants: Sekisui Chemical Co., Ltd., Osaka-shi, Osaka (JP); Kyushu University, National University Corporation, Fukuoka-shi, Fukuoka (JP)

(72) Inventors: Yasushi OKUMURA, Fukuoka (JP); Hirotsugu KIKUCHI, Fukuoka (JP); Hiroki HIGUCHI, Fukuoka (JP); Manabu TANIGUCHI, Fukuoka (JP); Kazuki YAMAMOTO, Kyoto (JP)

(21) Appl. No.: 14/390,564

(22) PCT Filed: Oct. 22, 2013
(86) PCT No.: PCT/JP2013/078575

§ 371 Date: Oct. 3, 2014

(51) Int. Cl. F04B 19/00; H01G 11/86

(52) U.S. Cl. CPC F04B 19/006; H01G 11/86

(57) ABSTRACT

Provided is a novel electroosmotic pump capable of being driven by AC voltage. An electroosmotic pump (2) includes a porous dielectric membrane (21), a first water-permeable electrode (22), a second water-permeable electrode (23), and a hydrophilic layer (22a). The first water-permeable electrode (22) is disposed on one side of the porous dielectric membrane (21). The second water-permeable electrode (23) is disposed on the other side of the porous dielectric membrane (21). The hydrophilic layer (22a) is disposed to one side with respect to the center of the porous dielectric membrane (21) in a thickness direction.

### TECHNICAL FIELD

The present invention relates to electroosmotic pumps, methods for manufacturing the same, and microfluidic devices.

### BACKGROUND ART

Recently, there have been increasing demands for micropumps which are a type of microfluidic device. The applications of micropumps are various, such as microreactors, hand-held medical devices, and fuel delivery for fuel cells. A mechanical micropump is conventionally known as a micropump. However, the mechanical micropump is composed of precision components. Therefore, the mechanical micropump is limited in cost reduction and size reduction. Against this background, attention is focused on an electroosmotic pump as a micropump to replace the mechanical pump (see, for example, Patent Literature 1).

Electroosmotic flow is liquid flow occurring when a voltage is applied to an electrical double layer where liquid and solid are in contact with each other. Electroosmotic flow has been found, together with electrophoresis, by the physicist Reuss in the early 19th century. In contrast to electrophoresis in which a solute or charged particles in liquid move, solid in the case of electroosmotic flow is immobilized. Therefore, bulk liquid moves. Electroosmotic flow is, observed in liquids composed of polarized molecules, including protic solvents, such as water and alcohol, ionic liquids, and so on. The electroosmotic pump is a pump configured to deliver a liquid using the electroosmotic flow.

### CITATION LIST

### Patent Literature

Patent Literature 1: JP-A-2010-216902

### SUMMARY OF INVENTION

### Technical Problem

Patent Literature 1 describes an example of the electroosmotic pump. In order to drive a conventional electroosmotic pump, such as the electroosmotic pump described in Patent Literature 1, it is necessary to apply a DC voltage thereto.

When a DC voltage is applied to the electroosmotic pump in order to activate it, an electrolytic reaction of the liquid concurrently occurs. When the electrolytic reaction of the liquid progresses, there arise problems, including a change in pH of the liquid and the generation of air bubbles in the liquid. Particularly when water is used as the liquid, this is dangerous because of the generation of hydrogen and oxygen. Therefore, a novel electroosmotic pump free of these problems is being strongly demanded.

A principal object of the present invention is to provide a novel electroosmotic pump capable of being driven by AC voltage.

### Solution to Problem

An electroosmotic pump according to the present invention includes a porous dielectric membrane, a first water-permeable electrode, a second water-permeable electrode, and a hydrophilic layer. The first water-permeable electrode is disposed on one side of the porous dielectric membrane. The second water-permeable electrode is disposed on the other side of the porous dielectric membrane. The hydrophilic layer is disposed to one side with respect to the center of the porous dielectric membrane in a thickness direction.

In the electroosmotic pump according to the present invention, each of the first water-permeable electrode and the second water-permeable electrode is preferably a porous conductive film deposited on a surface of the porous dielectric membrane, a conductive mesh, a sintered film of conductive particles or a patterned electrode printed on a porous insulating film.

In the electroosmotic pump according to the present invention, the hydrophilic layer may be formed on a surface of the first water-permeable electrode.

In the electroosmotic pump according to the present invention, the surface of the first water-permeable electrode maybe subjected to chemical or physical hydrophilic treatment.

In the electroosmotic pump according to the present invention, the hydrophilic layer may be laid on the first water-permeable electrode.

In the electroosmotic pump according to the present invention, the hydrophilic layer may be disposed between the porous dielectric membrane and the first water-permeable electrode.

The electroosmotic pump according to the present invention may further include a power source operable to apply an AC voltage between the first water-permeable electrode and the second water-permeable electrode, wherein the power source is configured to apply the AC voltage with a frequency of 1 MHz. or less.

In the electroosmotic pump according to the present invention, the porous dielectric membrane preferably has a thickness in a range of 5 μm to 100 μm.

In the electroosmotic pump according to the present invention, a ratio of the area of the water-permeable electrode to the square of the thickness of the porous dielectric membrane ((the area of the water-permeable electrode)/(the thickness of the porous dielectric membrane)²) is preferably more than 100.

In the electroosmotic pump according to the present invention, the porous dielectric membrane preferably has an average pore diameter in a range of 10 nm to 50 μm.

In the electroosmotic pump according to the present invention, the porous dielectric membrane preferably has a through hole passing through the porous dielectric membrane in a thickness direction thereof.

In the electroosmotic pump according to the present invention, each of the first and second water-permeable electrodes preferably has a through hole passing through the water-permeable electrode in a thickness direction thereof.

A first method for manufacturing an electroosmotic pump according to the present invention relates to a method for manufacturing the aforementioned electroosmotic pump. A plurality of the first water-permeable electrodes are formed at intervals on one of both principal surfaces of a porous mother membrane made of a dielectric material, combined with formation of a first mask impervious to liquid on a portion of the one principal surface of the mother membrane free from the formation of the first water-permeable electrodes. A plurality of the second water-permeable electrodes are formed opposite to the first water-permeable electrodes on the other principal surface of the mother membrane, combined with formation of a second mask impervious to liquid on a portion of the other principal surface of the mother membrane free from the formation of the second water-permeable electrodes. Thus, a mother laminate is produced. The mother laminate is cut at the portions where the first and second masks have been formed and thus divided into a plurality of sections to obtain a plurality of electroosmotic pumps.

A second method for manufacturing an electroosmotic pump according to the present invention relates to a method for manufacturing the aforementioned electroosmotic pump. A plurality of the first water-permeable electrodes are formed at intervals on one of both principal surfaces of a porous mother membrane made of a dielectric material, combined with formation of a first mask impervious to liquid on a portion of the one principal surface of the mother membrane free from the formation of the first water-permeable electrodes. A plurality of the second water-permeable electrodes are formed opposite to the first water-permeable electrodes on the other principal surface of the mother membrane, combined with formation of a second mask impervious to liquid on a portion of the other principal surface of the mother membrane free from the formation of the second water-permeable electrodes. Thus, an electroosmotic pump is obtained which includes a plurality of pump sections, each composed of a portion of the porous dielectric membrane and a pair of the first and second water-permeable electrodes.

A microfluidic device according to the present invention includes the aforementioned electroosmotic pump, a first reservoir disposed on one side of the porous dielectric membrane, and a second reservoir disposed on the other side of the porous dielectric membrane.

### Advantageous Effects of Invention

The present invention can provide a novel electroosmotic pump capable of being driven by AC voltage.

### BRIEF DESCRIPTION OF DRAWINGS

FIG. 1 is a schematic cross-sectional view of a liquid delivery module including an electroosmotic pump according to a first embodiment.

FIG. 2 is a schematic diagram of a hydrophilic layer of an AC-driven electroosmotic pump in the first embodiment.

FIG. 3 is a schematic cross-sectional view of a portion of an electroosmotic pump in a second embodiment.

FIG. 4 is a schematic cross-sectional view of a portion of an AC-driven electroosmotic pump in a third embodiment.

FIG. 5 is a schematic cross-sectional view of a mother laminate in a fourth embodiment.

FIG. 6 is a schematic cross-sectional view of a mother laminate in a fifth embodiment.

FIG. 7 is a schematic cross-sectional view of a microfluidic device in a sixth embodiment.

FIG. 8 is a photograph of a fracture cross-section of a track etched membrane used in an example.

FIG. 9 is a graph showing the relationship between applied voltage And flow rate in the example.

### DESCRIPTION OF EMBODIMENTS

Hereinafter, a description will be given of an exemplary preferred embodiment for working of the present invention. However, the following embodiment is simply illustrative. The present invention is not at all limited to embodiments below.

Throughout the drawings to which the embodiments and the like refer, elements having substantially the same functions will be referred to by the same reference signs. The drawings to which the embodiments and the like refer are schematically illustrated, and the dimensional ratios and the like of objects illustrated in the drawings may be different from those of the actual objects. Different drawings may have different dimensional ratios and the like of the objects. Dimensional ratios and the like of specific objects should be determined in consideration of the following descriptions.

### First Embodiment

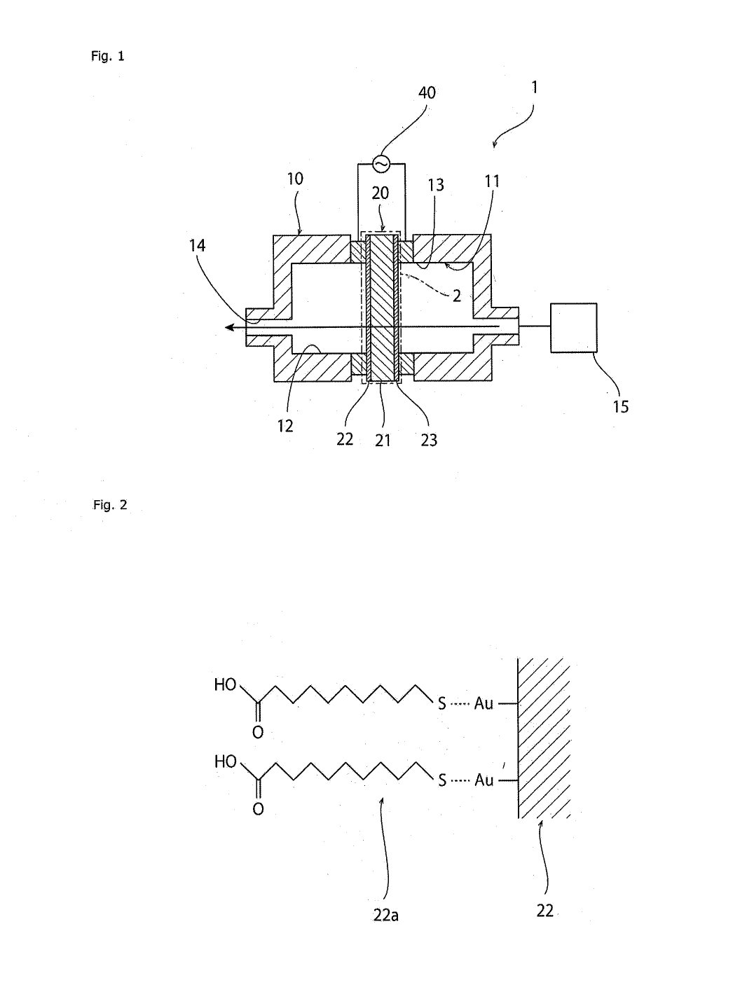

FIG. 1 is a schematic cross-sectional view of a liquid delivery module including an electroosmotic pump according to a first embodiment.

A liquid delivery module 1 shown in FIG. 1 includes holding jigs 10, 11 and an electroosmotic pump 2 mounted to the holding jigs 10, 11. The electroosmotic pump 2 includes a liquid delivery membrane 20. AC power is supplied to the electroosmotic pump 2. Each of the holding jigs 10, 11 includes a first reservoir 12 and a second reservoir 13. The liquid delivery membrane 20 of the electroosmotic pump 2 separates the first reservoir 12 and the second reservoir 13. The second reservoir 13 is connected to a liquid tank 15. Liquid is supplied from this liquid tank 15 to the second reservoir 13. The liquid supplied to the second reservoir 13 is delivered to the first reservoir 12 by the electroosmotic pump 2 and then discharged through an outlet 14 provided in the first reservoir 12.

The liquid delivery membrane 20 may have a flat shape, a sagging structure, a structure with a plurality of asperities or a folded structure. In these cases, the ratio of the actual area of the surface of the liquid delivery membrane 20 to the area thereof in plan view ((the actual area of the surface of the liquid delivery membrane 20)/(the area of the liquid delivery membrane 20 in plan view)) can be increased. Therefore, the liquid delivery capacity of the electroosmotic pump 2 can be increased.

The liquid delivery membrane 20 includes a porous dielectric membrane 21. The porous dielectric membrane 21 is made of an appropriate dielectric material. The porous dielectric membrane 21 may be formed of, for example, a polymer membrane made of polycarbonate (PC), polyester (PET), polyimide (PI) or so on or an inorganic membrane made of ceramic, silicon, glass, sintered aluminum oxide, sintered aluminum nitride, sintered mullite, sintered silicon carbide, sintered silicon nitride, sintered glass-ceramic material or so on. Furthermore, the porous dielectric membrane 21 may be, for example, a porous monolithic material.

The porous dielectric membrane 21 is preferably a track etched membrane. The track etched membrane used herein means a membrane subjected to track etching. The track etching refers to chemical etching in which a membrane is irradiated with strong heavy ions to form linear tracks in the membrane.

When the porous dielectric membrane 21 is a polymer membrane or an inorganic membrane, pores can be formed therein by irradiation of laser light.

The porous dielectric membrane 21 is preferably a membrane with open cells and preferably a membrane with a plurality of through holes passing through the membrane in its thickness direction. Normally, the track etched membrane has a large number of through holes passing through the membrane in its thickness direction.

Although no particular limitation is placed on the thickness of the porous dielectric membrane 21 the thickness is preferably about 5 μm to about 100 μm and more preferably 10 μm to 60 μm. By setting the thickness of the porous dielectric membrane 21 at such a thickness, the thickness of the porous dielectric membrane 21 can be balanced with the thickness of an electrical double layer to be formed. Therefore, the electroosmotic pump 2 can be suitably operated.

The average pore diameter of the porous dielectric membrane 21 is preferably 10 nm to 50 μm, more preferably 20 nm to 10 μm, and still more preferably 50 nm to 2 μm. If the average pore diameter of the porous dielectric membrane 21 is too small, the flow resistance may be large to make the amount of liquid delivered small. If the average pore diameter of the porous dielectric membrane 21 is too large, the hydraulic pressure of the delivered liquid may be reduced to deteriorate the energy efficiency of electroosmotic flow.

The porosity of the porous dielectric membrane 21 is preferably 1% to 50% and more preferably 3% to 30%. If the porosity of the porous dielectric membrane 21 is too high, adjacent pores are likely to merge with each other, which may present a problem with self-sustainability as a membrane. If the porosity of the porous dielectric membrane 21 is too low, the amount of liquid delivered may be small.

The pore density of the porous dielectric membrane 21 is preferably 4E2/cm² to 5E13/cm² and more preferably 3E4/cm² to 7.5E10/cm². If the pore density of the porous dielectric membrane 21 is too high, the porosity may be too high or the average pore diameter may be too small. If the pore density of the porous dielectric membrane 21 is too low, the energy efficiency of electroosmotic flow may be deteriorated.

A first water-permeable electrode 22 is provided on the side of the porous dielectric membrane 21 close to the first reservoir 12. A second water-permeable electrode 23 is provided on the side of the porous dielectric membrane 21 close to the second reservoir 13. It is sufficient that each of the first and second water-permeable electrodes 22, 23 be provided so that when a liquid is supplied, an electrical double layer is formed on the associated surface of the porous dielectric membrane 21. Each of the first and second water-permeable electrodes 22, 23 should preferably be in contact with the porous dielectric membrane 21. However, a local slight gap may exist between each of the first and second water-permeable electrodes 22, 23 and the porous dielectric membrane 21.

The first and second water-permeable electrodes 22, 23 are provided to allow liquid to permeate them in their thickness direction. Each of the first and second water-permeable electrodes 22, 23 preferably has through holes passing through it in its thickness direction. These through holes in the first and second water-permeable electrodes 22, 23 are preferably connected to the through holes in the porous dielectric membrane 21.

Each of the first and second water-permeable electrodes 22, 23 can be formed, for example, by depositing a conductive material, such as metal, on the porous dielectric membrane 21 so that the pores in the porous dielectric membrane 21 are not fully closed. Alternatively, the first and second water-permeable electrodes 22, 23 may be formed of one of a conductive mesh, a sintered film of conductive particles , and a patterned electrode printed on a porous insulating film. The patterned electrode may be formed of an electrode patterned into, for example, a mesh electrode, a comb-shaped electrode, a staggered electrode, a fractal patterned electrode or so on.

Although no particular limitation is placed on the material for the first and second water-permeable electrodes 22, 23 so long as it is a conductive material, the first and second water-permeable electrodes 22, 23 are preferably made of a good conductive material. Specifically, each of the first and second water-permeable electrodes 22, 23 may be made of at least one metal of the group consisting of gold, silver, and copper, a composite material consisting predominantly of carbon, such as carbon nanotubes, a transparent conductive oxide, such as indium tin oxide (ITO), or so on.

The electroosmotic pump 2 is connected to an AC power source 40. This AC power source 40 applies an AC voltage between the first and second water-permeable electrodes 22, 23. A highly-elastic conductor, such as conductive rubber, may be interposed in the connection between the electroosmotic pump 2 and the AC power source 40. The AC power source 40 preferably applies an AC voltage with a frequency of 1 MHz or less between the first and second water-permeable electrodes 22, 23, more preferably an AC voltage of 0.5 Hz to 20 kHz, and still more preferably an AC voltage of 1 Hz to 100 Hz. If the frequency of the AC voltage applied between the first and second water-permeable electrodes 22, 23 is too high, the electroosmotic pump 2 may not be suitably operated.

As shown in FIG. 2, in the electroosmotic pump 2, a hydrophilic layer 22a is formed on a surface of the first water-permeable electrode 22. Specifically, in this embodiment, the surface of the first water-permeable electrode 22 is subjected to hydrophilic treatment, so that the hydrophilic layer 22a is formed thereon. The hydrophilic layer 22a may instead be formed by laying a hydrophilized porous thin film on the surface of the first water-permeable electrode 22, but may be formed by chemically or physically modifying the surface of the first water-permeable electrode 22 with molecules having hydrophilic functional groups.

An example of a specific method for chemically modifying the surface of the first water-permeable electrode 22 with molecules having hydrophilic functional groups is, when the first water-permeable electrode 22 contains gold, to subject the surface of the first water-permeable electrode 22 to surface treatment with a self-assembly reagent or the like capable of providing gold-thiol bond to thus forma hydrophilic layer 22a.

In this case, molecules with a main chain containing an end of a thiol functional group and the other end constituted by a hydrophilic group are selected as a self-assembly reagent that can be preferably used. Specific examples of such a self-assembly reagent include:

HS—(CH₂)ₙ—COOH (1);

HOOC—(CH₂)ₙ—S—S—(CH₂)ₙ—COOH (2);

HS—(CH₂)ₙ—OH (3);

HS—(CH₂)ₙ—(OCH₂—CH₂)₆—(CH₂)ₙ—OCH₂—COOH (4);

HS—(CH₂)ₙ—NH₃Cl (5);

and

HS—(CH₂)ₙ—(OCH₂—CH₂)₆—NH₃Cl (6).

FIG. 2 schematically shows the hydrophilic layer 22a formed using such a self-assembly reagent as described above (specifically, 1,1-mercaptoundecanoic acid).

Prior to the hydrophilic treatment with a self-assembly reagent, degreasing treatment, supercritical CO₂ cleaning, plasma treatment, corona discharge treatment or the like maybe additionally performed.

Another example of the specific method for chemically modifying the surface of the first water-permeable electrode 22 with molecules having hydrophilic functional groups is the method of coating the surface with a polymer containing a hydrophilic functional group. An example of the polymer containing hydrophilic functional group that is preferably used is polyurethane urea containing a phosphorylcholine group. Alternatively, examples of the polymer containing a hydrophilic functional group that can be used include polylysine and polyallylamine which have a large number of amino groups in their molecular chains, hydroxypropyl cellulose, and hydroxyethyl cellulose. The method for chemically modifying the surface of the first water-permeable electrode 22 with molecules having hydrophilic functional groups is not limited to the above and any chemically modifying hydrophilic treatment technique that can be known by those skilled in the art is applicable.

As thus far described, in this embodiment, the hydrophilic layer 22a is disposed to one side with respect to the center of the porous dielectric membrane 21 in its thickness direction. The number of counter ions in liquid near the surface of the hydrophilic layer 22a is different from that near the surface of the water-permeable electrode 23. For this reason, upon application of an AC voltage, the amount of motion of liquid from the second reservoir 13 toward the first reservoir 12 is different from and asymmetric with the amount of motion of liquid from the second reservoir 13 to the first reservoir 12. Therefore, when an AC voltage is applied to the electroosmotic pump 2, the liquid can be delivered from one of the reservoirs to the other reservoir. Thus, the electroosmotic pump 2 operates. In other words, the electroosmotic pump 2 can be driven by an AC voltage. Hence, unlike the case where a DC voltage is applied the electroosmotic pump, it is less likely that during drive of the electroosmotic pump 2 the liquid may change the pH or generate air bubbles because of a concurrent electrolytic reaction.

From the viewpoint of further increasing the liquid delivery capacity of the electroosmotic pump 2, the hydrophilic layer 22a should preferably be formed on a surface of the first water-permeable electrode 22 located on the side opposite to the porous dielectric membrane 21.

The ratio of the area of the first and second water-permeable electrodes 22, 23 to the square of the thickness of the porous dielectric membrane 21 ((the area of the first and second water-permeable electrodes 22, 23)/(the thickness of the porous dielectric membrane 21)²) is preferably more than 100. If this ratio is too small, the efficiency of liquid delivery becomes poor. There is no upper limit on this ratio.

The electroosmotic pump of the present invention is operable by the application of an AC voltage thereto but does not necessarily have to be inoperable upon application of a DC voltage thereto.

Hereinafter, a description will be given of other exemplary preferred embodiments for working of the present invention. In the following description, elements having substantially the same functions as those in the first embodiment are referred to by the common references and further explanation thereof will be omitted.

### Second Embodiment

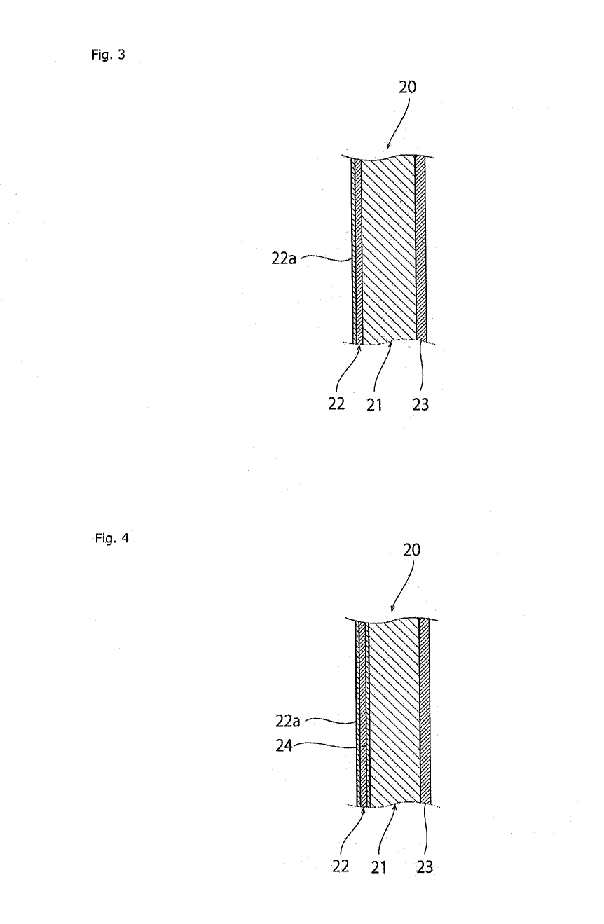

FIG. 3 is a schematic cross-sectional view of a portion of an electroosmotic pump in a second embodiment.

As shown in FIG. 3, in the second embodiment, the hydrophilic layer 22a is formed of a film disposed on the first water-permeable electrode 22 and made of a hydrophilic material. Also in this case, the electroosmotic pump can be driven by AC voltage like the electroosmotic pump 2 of the first embodiment.

The hydrophilic layer 22a does not necessarily have to be in contact with the first water-permeable electrode 22. The hydrophilic layer 22a may be spaced away from the first water-permeable electrode 22 so long as the distance between them is about 50 μm or less. In other words, the hydrophilic layer 22a may be provided superior to the first water-permeable electrode 22.

### Third Embodiment

FIG. 4 is a schematic cross-sectional view of a portion of an electroosmotic pump in a third embodiment.

As shown in FIG. 4, in the third embodiment, in addition to the hydrophilic layer 22a, an additional hydrophilic layer 24 is provided between the first water-permeable electrode 22 and the porous dielectric membrane 21. By the provision of not only the hydrophilic layer 22a but also the hydrophilic layer 24, the liquid delivery capacity can be further increased.

The hydrophilic layer 24 can be formed, for example, by interlaying a film obtained by chemically hydrophilizing sintered polyethylene powder body.

In this embodiment, a description has been given of the example where the hydrophilic layer 24 is provided in addition to the hydrophilic layer 22a. However, the present invention is not limited to this. For example, without providing any hydrophilic layer on the side of the first water-permeable electrode opposite to the porous dielectric membrane, hydrophilic layer may be provided between the first water-permeable electrode and the porous dielectric membrane. Also in this case, the electroosmotic pump can be driven by an AC voltage.

### Fourth Embodiment

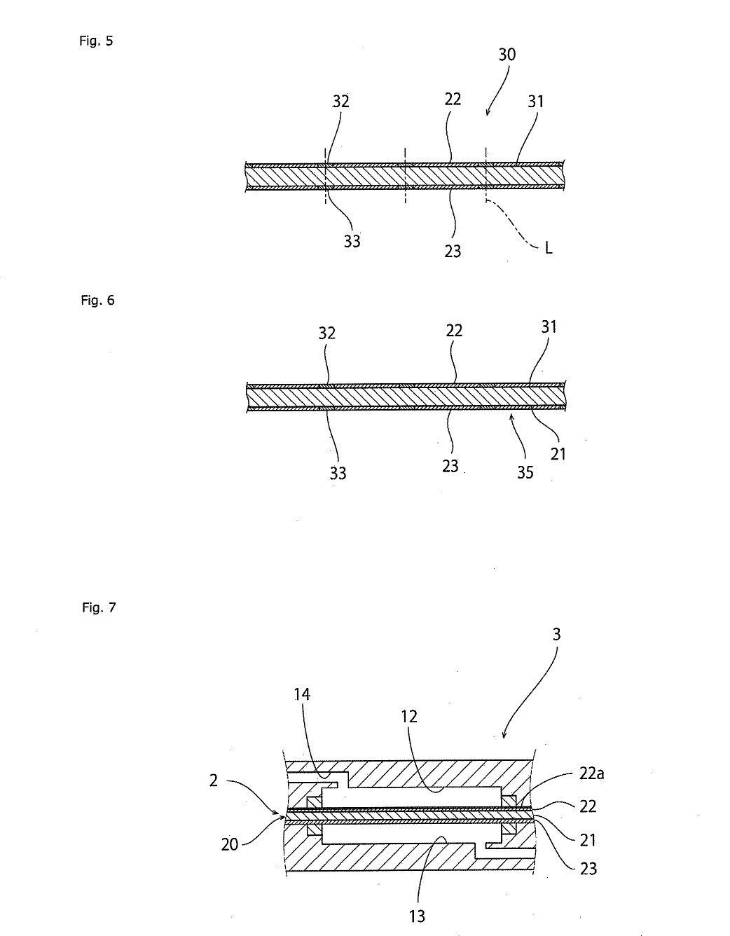

FIG. 5 is a schematic cross-sectional view of a mother laminate in a fourth embodiment.

In this embodiment, in producing an electroosmotic pump, a porous mother membrane 31 made of a dielectric material is first used. This mother membrane 31 is used for constituting plurality of porous dielectric membranes 21. Next, a plurality of first water-permeable electrodes 22 are formed at intervals on one of both principal surfaces of the mother membrane 31 and a first mask 32 substantially impervious to liquid is formed on a portion of the one principal surface of the mother membrane free from the formation of the first water-permeable electrodes 22. A plurality of second water-permeable electrodes 23 are formed opposite to the first water-permeable electrodes 22 on the other principal surface of the mother membrane 31 and a second mask 33 substantially impervious to liquid is formed on a portion of the other principal surface of the mother membrane free from the formation of the second water-permeable electrodes 23. Thus, a mother laminate 30 is produced. Next, the mother laminate 30 is cut at the portions where the first and second masks 32, 33 have been formed and thus divided into a plurality of electroosmotic pumps.

By producing the electroosmotic pumps in the above manner, a plurality of electroosmotic pumps can be manufactured with high production efficiency.

Each of the first and second masks 32, 33 can be formed of, for example, a self-adhesive film, hot-melt resin, thermosetting resin, a punched rubber film or so on. The first and second masks 32, 33 may be concurrently formed. Furthermore, the first and second masks 32, 33 may be infiltrated into and fused to the porous dielectric membrane 21.

### Fifth Embodiment

FIG. 6 is a schematic cross-sectional view of a mother laminate in a fifth embodiment.

In this embodiment, a mother laminate 30 produced substantially in the same manner as in the fourth embodiment is served as an electroosmotic pump as it is. By doing so, an, electroosmotic pump can be produced which includes a plurality of pump sections 35, each including a porous dielectric membrane 21 constituted by a portion of the mother membrane 31 and a pair of water-permeable electrodes 22, 23.

### Sixth Embodiment

FIG. 7 is a schematic cross-sectional view of a microfluidic device in a sixth embodiment.

The electroosmotic pump according to the present invention is applicable to, for example, a microfluidic device.

A microfluidic device 3 shown in FIG. 7 includes an electroosmotic pump 2, a first reservoir 12, and a second reservoir 13. Like the first embodiment, the first reservoir 12 is disposed on one side of a porous dielectric membrane 21 of a liquid delivery membrane 20 of the electroosmotic pump 2 and the second reservoir 13 is disposed on the other side of the porous dielectric membrane 21. The first reservoir 12 and the second reservoir 13 are separated by the liquid delivery membrane 20. AC power is supplied to the electroosmotic pump 2. Liquid is supplied from a liquid tank 15 to the second reservoir 13. The liquid supplied to the second reservoir 13 is delivered to the first reservoir 12 by the electroosmotic pump 2 and then discharged through an outlet 14 provided in the first reservoir 12.

The present invention will be described below in further detail with reference to a specific example, but the present invention is not at all limited by the following example, and modifications and variations may be appropriately made therein without changing the gist of the invention.

### EXAMPLE

An electroosmotic pump having substantially the same structure as the electroosmotic pump 2 according to the first embodiment was produced in the following manner. A 20-nm-thick gold film was deposited on both surfaces of a track etched membrane with a thickness of 20 μm and an average pore diameter of 400 nm (Isopore membrane filter HTTP04700, Millipore) using a magnetron sputtering system (MSP-1S, Vacuum Device Inc.) to form first and second water-permeable electrodes on the membrane. At that time, it was confirmed that the front and back sides of the membrane were electrically insulated. Next, the surface of the first water-permeable electrode on the side opposite to the porous dielectric membrane was treated with 1,1-mercaptoundecanoic acid to form a hydrophilic layer. Through the above processes, an electroosmotic pump according to an example was produced.

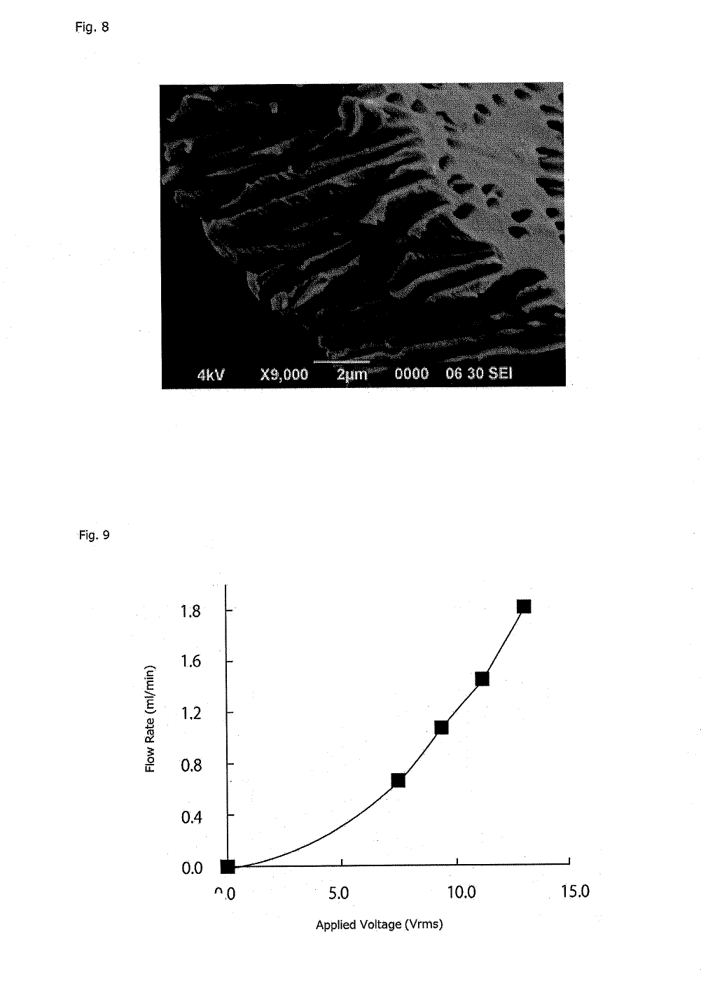

The first and second water-permeable electrodes made of gold were connected through respective conductive rubber electrodes to an AC power source. The distance between the first water-permeable electrode and the second water-permeable electrode was 20 μm equal to the thickness of the track etched membrane. FIG. 8 is a photograph of a fracture cross-section of the track etched membrane used in the example.

A 25-Hz AC voltage was applied to the produced electroosmotic pump while the back pressure of the liquid (deionized water) was kept zero. The results are shown in FIG. 9.

In this example, substantially no air bubble was generated even when the AC voltage was continuously applied for 10 minutes.

The results shown in FIG. 9 reveal that the electroosmotic pump produced in this example is driven upon application of an AC voltage. The results also reveal that the flow rate can be increased by increasing the voltage applied.

Furthermore, a liquid containing a pH indicator dissolved in deionized water was supplied to the apparatus produced in this example and a 9.34-Vrms AC voltage was applied between the first and second water-permeable electrodes with 25 Hz for 15 minutes. Thereafter, the color tones of the first and second reservoirs were observed. The color tones of the first and second reservoirs were similar to those prior to the application of the voltage, their pH values were unchanged, and no gas due to electrolysis was generated. Also when a 0.9% by weight NaCl aqueous solution was used as a solvent, the first and second reservoirs exhibited no change in pH and no gas due to electrolysis was generated.

In contrast, when a 9.34-V DC voltage was applied between the first and second water-permeable electrodes for 15 minutes, the color tone of the first reservoir changed into a weakly acid color, the color tone of the second reservoir changed into a weakly alkaline color, and a gas due to electrolysis was generated. Furthermore, when a 0.9% by weight NaCl aqueous solution was used as a solvent, the color tone of the first reservoir changed into a strongly acid color, the color tone of the second reservoir changed into a strongly alkaline color, and a gas due to electrolysis was generated.

### REFERENCE SIGNS LIST

1: liquid delivery module
2: electroosmotic pump
3: microfluidic device
10: holding jig
11: holding jig
12: first reservoir
13: second reservoir
14: outlet
15: liquid tank
20: liquid delivery membrane
21: porous dielectric membrane
22: first water-permeable electrode
22a: hydrophilic layer
23: second water-permeable electrode
24: hydrophilic layer
30: mother laminate
31: mother membrane
32: first Mask
33: second mask
35: electroosmotic pump including a plurality of pump sections
40: AC power source

1. An electroosmotic pump comprising:
a porous dielectric membrane;
a first water-permeable electrode disposed on one side of the porous dielectric membrane;
a second water-permeable electrode disposed on the other side of the porous dielectric membrane; and
a hydrophilic layer disposed to one side with respect to the center of the porous dielectric membrane in a thickness direction.

2. The electroosmotic pump according to claim 1, wherein each of the first water-permeable electrode and the second water-permeable electrode is a porous conductive film deposited on a surface of the porous dielectric membrane, a conductive mesh, a sintered film of conductive particles or a patterned electrode printed on a porous insulating film.

3. The electroosmotic pump according to claim 1, wherein the hydrophilic layer is formed on a surface of the first water-permeable electrode.

4. The electroosmotic pump according to claim 3, wherein the surface of the first water-permeable electrode is subjected to chemical or physical hydrophilic treatment.

5. The electroosmotic pump according to claim 3, wherein the hydrophilic layer is laid on the first water-permeable electrode.

6. The electroosmotic pump according to claim 1, wherein the hydrophilic layer is disposed between the porous dielectric membrane and the first water-permeable electrode.

7. The electroosmotic pump according to claim 1, further comprising a power source operable to apply an AC voltage between the first water-permeable electrode and the second water-permeable electrode, wherein the power source is configured to apply the AC voltage with a frequency of 1 MHz or less.

8. The electroosmotic pump according to claim 1, wherein the porous dielectric membrane has a thickness in a range of 5 μm to 100 μm.

9. The electroosmotic pump according to claim 1, wherein a ratio of the area of the water-permeable electrode to the square of the thickness of the porous dielectric membrane ((the area of the water-permeable electrode)/(the thickness of the porous dielectric membrane)) is more than 100.

10. The electroosmotic pump according to claim 1, wherein the porous dielectric membrane has an average pore diameter in a range of 10 nm to 50 μm.

11. The electroosmotic pump according to claim 1, wherein the porous dielectric membrane has a through hole passing through the porous dielectric membrane in a thickness direction thereof.

12. The electroosmotic pump according to claim 1, wherein each of the first and second water-permeable electrodes has a through hole passing through the water-permeable electrode in a thickness direction thereof.

13. A method for manufacturing the electroosmotic pump according to claim 1, the method comprising the steps of:
forming a plurality of the first water-permeable electrodes at intervals on one of both principal surfaces of a porous mother membrane made of a dielectric material, combined with formation of a first mask impervious to liquid on a portion of the one principal surface of the mother membrane free from the formation of the first water-permeable electrodes, and forming a plurality of the second water-permeable electrodes opposite to the first water-permeable electrodes on the other principal surface of the mother membrane, combined with formation of a second mask impervious to liquid on a portion of the other principal surface of the mother membrane free from the formation of the second water-permeable electrodes, thus producing a mother laminate; and
cutting the mother laminate at the portions where the first and second masks have been formed and thus dividing the mother laminate into a plurality of sections to obtain a plurality of electroosmotic pumps.

14. A method for manufacturing the electroosmotic pump according to claim 1, wherein a plurality of the first water-permeable electrodes are formed at intervals on one of both principal surfaces of the porous dielectric membrane, combined with formation of a first mask impervious to liquid on a portion of the one principal surface of the porous dielectric membrane free from the formation of the first water-permeable electrodes, and a plurality of the second water-permeable electrodes are formed opposite to the first water-permeable electrodes on the other principal surface of the porous dielectric membrane, combined with formation of a second mask impervious to liquid on a portion of the other principal surface of the porous dielectric membrane free from the formation of the second water-permeable electrodes, thus obtaining an electroosmotic pump which includes a plurality of pump sections each composed of a portion of the porous dielectric membrane and a pair of the first and second water-permeable electrodes.

15. A microfluidic device comprising:
the electroosmotic pump according to claim 1;
a first reservoir disposed on one side of the porous dielectric membrane; and
a second reservoir disposed on the other side of the porous dielectric membrane.
